(19) United States
(12) Patent Application Publication
(10) Pub. No.: US 2024/0274988 A1
(43) Pub. Date: Aug. 15, 2024

(54) CELL-CONTACTING SYSTEM FOR A BATTERY MODULE, BATTERY MODULE AND METHOD FOR FURNISHING SUCH A CELL-CONTACTING SYSTEM

(71) Applicant: Diehl AKO Stiftung & Co. KG, Wangen (DE)

(72) Inventor: Mateusz Kurpiel, Wangen (DE)

(21) Appl. No.: 18/642,884

(22) Filed: Apr. 23, 2024

Related U.S. Application Data
(63) Continuation of application No. PCT/EP2023/050602, filed on Jan. 12, 2023.

(30) Foreign Application Priority Data
Jan. 31, 2022 (DE) 10 2022 102 131.9
May 6, 2022 (DE) 10 2022 111 311.6

(51) Int. Cl. H01M 50/519; H01M 10/48

(52) U.S. Cl. CPC H01M 50/519; H01M 10/482; H01M 10/486

(57) ABSTRACT

A cell-contacting system for a battery module having battery cells includes cell connectors for electrically conductively connecting cell terminals of different battery cells. and a circuit board having signal lines each routing measured values from one of the cell connectors to a signal management circuit or to a connection interface. At least one temperature acquisition device measures the temperature of the battery cells at one of the cell connectors. The temperature acquisition device is formed of a circuit board edge section integrated with the circuit board and projecting from the circuit board into a region of the respective cell connector, a temperature sensor mounted on the circuit board edge section and a cell connector overlap section of the respective cell connector overlapping the temperature sensor on the circuit board edge section. A battery module and a method for furnishing a cell-contacting system are also provided.

### CROSS-REFERENCE TO RELATED APPLICATION

This application is a continuation, under 35 U.S.C. § 120, of copending International Patent Application PCT/EP2023/050602, filed Jan. 12, 2023 which designated the United States; this application also claims the priority, under 35 U.S.C. § 119, of German Patent Applications DE 10 2022 102 131.9, filed Jan. 31, 2022 and DE 10 2022 111 311.6; filed May 6, 2022; the prior applications are herewith incorporated by reference in their entirety.

### FIELD AND BACKGROUND OF THE INVENTION

The present invention relates to a cell-contacting system for a battery module having a plurality of battery cells, a battery module having such a cell-contacting system, and a method for furnishing or equipping such a cell-contacting system.

Cell management controllers (CMC), which monitor the individual battery cells of the battery module in order to carry out, for example, charging processes, balancing of the voltages and the states of charge, temperature-control processes, etc. for the battery cells, require a cell-contacting system for contacting the battery cells in order to receive corresponding measurement signals for the potentials and the temperatures of the battery cells. The cell-contacting system usually includes a plurality of cell connectors for electrically conductively connecting cell terminals of different battery cells, and a printed circuit board having a plurality of signal lines each for passing measurement values from one of the plurality of cell connectors to a signal management circuit or a connecting interface. Conventional cell-contacting systems usually require a great deal of effort in terms of manufacture and assembly for connecting the signal sources to the signal line system formed by the printed circuit board and for inserting temperature detection devices. In conventional cell-contacting systems, the temperature detection devices generally contain a temperature sensor, which is mounted on a cell connector or a carrier element fastened to the cell connector and is coupled to the printed circuit board via a connecting element. As is known, the carrier element is fastened to the cell connector, for example, by adhesive bonding, screwing, soldering or welding and/or by using hooks or tongues.

### SUMMARY OF THE INVENTION

It is accordingly an object of the invention to provide an improved cell-contacting system for a battery module, a battery module and a method for producing such a cell-contacting system, which overcome the hereinafore-mentioned disadvantages of the heretofore-known systems, modules and methods of this general type and which can be equipped with a temperature detection device in a simple manner.

With the foregoing and other objects in view there is provided, in accordance with the invention, a cell-contacting system for a battery module having a plurality of battery cells, which comprises a plurality of cell connectors for electrically conductively connecting cell terminals of different battery cells, and a printed circuit board having a plurality of signal lines each for passing measurement values from one of the plurality of cell connectors to a signal management circuit or a connecting interface. The plurality of cell connectors serve as a power line system and the printed circuit board serves as a signal line system. The cell-contacting system also has at least one temperature detection device for measuring the temperature of the battery cells at one of the plurality of cell connectors. According to the invention, this at least one temperature detection device is formed from a printed circuit board edge section which is integrated with the printed circuit board and projects from the printed circuit board into a region of the respective cell connector, a temperature sensor which is mounted on the printed circuit board edge section, and a cell connector overlap section of the respective cell connector, which cell connector overlap section overlaps the temperature sensor on the printed circuit board edge section.

The dependent claims relate to particularly advantageous refinements and developments of the invention.

The use of a temperature detection device configured in such a way has several advantages. Due to the integration of the temperature sensor on the printed circuit board by the projecting printed circuit board edge section, neither additional measuring elements separate from the printed circuit board or on a separate printed circuit board nor additional connecting elements between the measuring elements and the printed circuit board are required, and therefore fewer components and fewer assembly steps are required for installing the temperature detection device, this allowing simpler/less complex configuration of the cell-contacting system and simpler and more cost-effective production and assembly of the cell-contacting system. A lower overall height of the cell-contacting system in comparison to the use of conventional systems is also possible using the temperature detection device according to the invention since a flat installation structure is possible. The construction according to the invention of the temperature detection device can also be particularly readily used in conjunction with a rigid printed circuit board, this having further advantages because a rigid printed circuit board allows simple handling during manufacture and assembly and also mounting of components such as, for example, electronic circuit elements on the rigid printed circuit board. The entire battery module can also be produced more easily and reliably due to the cell-contacting system being easier to produce.

According to the invention, the cell-contacting system contains a special temperature detection device. In principle, this configuration can be combined with any desired basic constructions of the cell connectors, any desired printed circuit boards (preferably rigid, selectively also a flexible printed circuit board), any desired connecting constructions between voltage tap points on the cell connectors and the printed circuit board and any desired dimensions of the battery module (i.e. in particular number and size of battery cells). The cell-contacting system can also contain any desired number of temperature detection devices configured according to the invention for temperature measurement at a plurality (at some or even at all) of the cell connectors, and the temperature detection devices can in principle include any desired types of temperature sensor (e.g. NTC temperature sensor, selectively an SMD version).

In a preferred refinement of the invention, the at least one temperature detection device also has a heat-conducting layer between the temperature sensor and the cell connector overlap section of the respective cell connector. The heat-conducting layer serves to transfer the heat from the cell connector to the temperature sensor. This heat-conducting layer of the temperature detection device can be attached to the temperature sensor or to the cell connector overlap section of the respective cell connector.

The cell connector overlap section of the temperature detection device preferably (but not absolutely necessarily) overlaps the entire printed circuit board edge section of the temperature detection device.

The construction of the temperature detection device can preferably be configured in such a way that at least one of the following aspects is satisfied: (i) the cell connector overlap section (at least partially) extends higher than the other contact region of the respective cell connector; (ii) the printed circuit board edge section is positioned substantially in the same plane as the printed circuit board or deeper than the printed circuit board; and (iii) the printed circuit board edge section is positioned in substantially the same plane as the respective cell connector or deeper than the respective cell connector. These statements each relate to the upper sides, averted from the battery cells, of the components. As an alternative or in addition, the construction of the temperature detection device is preferably also configured in such a way that the printed circuit board edge section has substantially the same layer thickness as the printed circuit board or a lower layer thickness than the printed circuit board.

In one refinement of the invention, the plurality of cell connectors each have two contact regions in each case to a cell terminal of a battery cell, and a compensation region between the two contact regions. In this case, the temperature detection device is disposed in the region of one of the two contact regions of the respective cell connector.

The invention also relates to a battery module which includes a plurality of battery cells and a cell-contacting system of the invention described above. The same advantages as explained above in conjunction with the cell-contacting system according to the invention can be achieved with this battery module.

The battery cells are connected to each other via the cell connectors of the cell-contacting system and can be connected to a load or a charging system via an electrical connection. The battery cells and the cell-contacting system are preferably both accommodated in a module housing. The invention is not restricted to a specific type, number, size or arrangement of the plurality of battery cells. The invention can also be used for Li-ion battery modules in particular.

In general, the battery module also has at least one battery module controller for operating the battery module, the battery module controller being connected to the at least one signal management circuit (integrated into the printed circuit board or connected as an external circuit to the printed circuit board via a connection interface). The module controller carries out, for example, charging processes, balancing of the voltages and the states of charge, temperature-control processes such as, in particular, cooling processes and the like at least partially depending on the measurement signals received by the cell-contacting system.

The invention can advantageously be used for battery modules for vehicles, in particular electric vehicles and hybrid vehicles and in particular motor vehicles and motorcycles, and also for energy storage systems and other electrical devices (e.g. electronic domestic appliances).

With the objects of the invention in view, there is also provided a method for furnishing or equipping a cell-contacting system for a battery module having a plurality of battery cells, the cell-contacting system including a plurality of cell connectors for electrically conductively connecting cell terminals of different battery cells, and a printed circuit board having a plurality of signal lines each for passing measurement values from one of the plurality of cell connectors to a signal management circuit or a connecting interface, the cell-contacting system having at least one temperature detection device for measuring the temperature of the battery cells at one of the plurality of cell connectors, i.e. a method for producing the cell-contacting system described above. This method comprises: providing the printed circuit board with at least one integrated printed circuit board edge section in such a way that the printed circuit board edge section then projects from the printed circuit board into a region of the respective cell connector when the cell-contacting system is in the assembled state; mounting a temperature sensor on the printed circuit board edge section; and providing the respective cell connector with a cell connector overlap section in such a way that the cell connector overlap section then overlaps the temperature sensor on the printed circuit board edge section when the cell-contacting system is in the assembled state. The same advantages as explained above in conjunction with the cell-contacting system according to the invention can be achieved with this method. The method preferably also includes inserting a heat-conducting layer between the temperature sensor and the cell connector overlap section of the respective cell connector. In addition, the constituent parts of the temperature detection device are configured and positioned as explained above in conjunction with the cell-contacting system.

Other features which are considered as characteristic for the invention are set forth in the appended claims and the subject matter of the invention is defined by the appended claims.

Although the invention is illustrated and described herein as embodied in a cell-contacting system for a battery module, a battery module and a method for producing such a cell-contacting system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective plan view of a battery module according to an exemplary embodiment of the invention;

FIG. 2 is a fragmentary, perspective plan view of a cell-contacting system according to an exemplary embodiment of the invention for the battery module of FIG. 1;

FIG. 3 is a fragmentary, perspective plan view of FIG. 2 without cell connectors already placed in the region of the temperature detection device; and

FIG. 4 is a perspective plan view of a cell connector of FIG. 2 which is placed in the region of the temperature detection device.

### DETAILED DESCRIPTION OF THE INVENTION

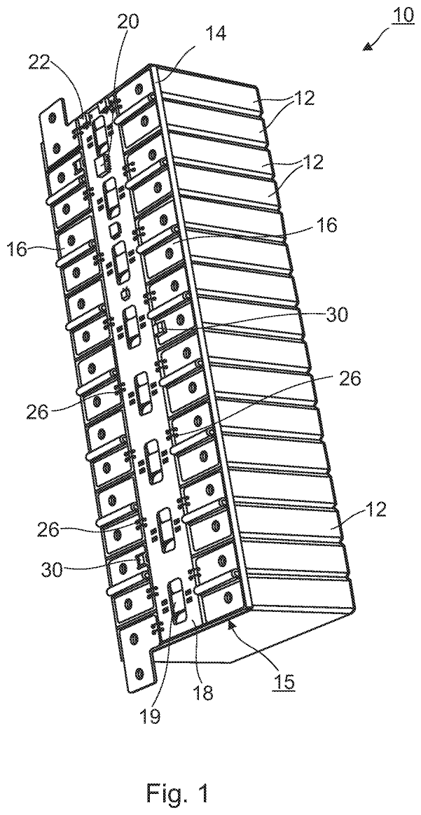

Referring now to the figures of the drawings in detail and first, particularly, to FIGS. 1-4 thereof, there is seen an exemplary embodiment of a battery module having a cell-contacting system according to the invention.

The battery module 10 has a large number of battery cells (e.g. Li-ion battery cells) 12. In this exemplary embodiment, the battery cells 12 are disposed next to one another in the direction from top to bottom in FIG. 1 and respectively have a negative connection in the end region on the left-hand-side or right-hand-side in FIG. 1 and a positive connection in the end region on the right-hand-side or left-hand-side in FIG. 1, the negative and positive connections of the battery cells 12 being disposed in an alternating manner, so that a negative connection of one battery cell is next to a positive connection of an adjacent battery cell.

The battery module 10 also has a cell-contacting system 15, which is disposed above the battery cells 12, preferably on a carrier plate 14. The battery cells 12, together with the cell-contacting system 15, are usually disposed in a module housing (not illustrated).

The cell-contacting system 15 has a large number of cell connectors 16 which form a power line system. In this exemplary embodiment, the cell connectors 16 each have two contact regions 16a, 16b and a (preferably elastic) compensation region 16c between the two contact regions 16a, 16b and are attached to the battery cells 12 in such a way that they each couple the negative connection of one battery cell 12 to the positive connection of an adjacent battery cell 12 via their two contact regions 16a, 16b, this creating a series circuit of the battery cells 12 in the battery module 10. The battery cells 12 can additionally be connected to a load or a charging system via an electrical connection of the battery module 10.

The cell-contacting system 15 also has a (preferably rigid) printed circuit board 18 which forms the signal line system and, in the region between the two rows of cell connectors 16, is disposed above the battery cells 12 over the entire length of the battery cell arrangement. The shape and the size of the printed circuit board 18 can be adapted, in principle, to any desired constructions of battery modules, in particular to any desired arrangements, sizes and numbers of battery cells. In this exemplary embodiment, the printed circuit board 18 is of substantially rectangular configuration. As illustrated in FIG. 1, the printed circuit board 18 preferably also has some holes as ventilation openings 19 for assisting a cooling process for the battery cells 12 situated beneath it.

Although not illustrated in FIG. 1 for reasons of simplicity and better understanding, the printed circuit board 18 has a plurality of signal lines which each connect a signal source of a cell connector 16 to an electronic signal management circuit 20. The signal management circuit 20 is configured, for example, in order to carry out the voltage measurement method and to evaluate the measurement signals received from the signal sources of the cell connectors 16. In this exemplary embodiment, the signal management circuit 20 is integrated on the printed circuit board 18 and connected to a connecting interface 22 via which the signal management circuit 20 can be connected to a battery module controller. This battery module controller serves, for example, to carry out charging processes, balancing of the voltages and the states of charge, temperature-control processes such as, in particular, cooling processes etc., these processes being carried out at least partially depending on the measurement signals received by the cell-contacting system 15 or the measurement values for the measurement signals received by the signal management circuit 20. In an alternative embodiment of the invention, the signal management circuit 20 can also be configured or located externally from the printed circuit board 18. In this case, the signal lines of the printed circuit board 18 are directly connected to the connecting interface 22 and the external signal management circuit is coupled to the connecting interface 22 of the printed circuit board 18 and also coupled to the battery module controller via a further connecting interface. The cell-contacting system 15, the signal management circuit 20 and the battery module controller together can also be referred to as the cell management controller (CMC).

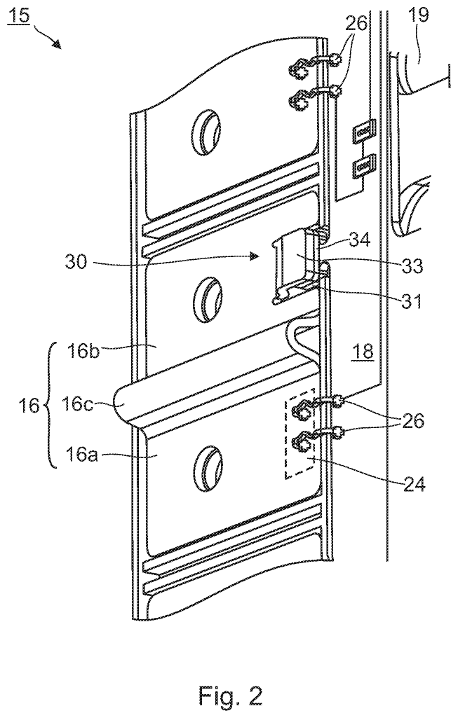

As illustrated in FIGS. 1 and 2, there are two types of signal sources in this cell-contacting system 15. Firstly, all (selectively only a majority) of the cell connectors 16 each have a voltage tap point 24 as a first type of signal source for measuring the voltage of the battery cells 12. In addition, for a pair of (selectively likewise for all the) cell connectors 16, a temperature-control device 30 is provided as a second type of signal source for measuring the temperature of the battery cells 12 in each case.

The voltage tap points 24 can each be formed directly by a contact region 16a, 16b of a cell connector 16. In order to connect the voltage tap points 24 to the signal lines of the printed circuit board 18, in each case at least one connecting element 26 is (in this exemplary embodiment in each case two connecting elements are) coupled to the printed circuit board 18 and to the cell connector 16 at corresponding contact points 28a, 28b. The structures of these connecting elements 26 are in principle arbitrary within the scope of the invention. As can be seen in FIGS. 2 to 4, the connecting elements 26 can be configured, for example, as press-fit connecting elements which are formed from metal and are pushed into corresponding contact points 28a in the form of holes in the printed circuit board 18 and into corresponding contact points 28b in the form of holes in the cell connectors 16. If the top side of the printed circuit board 18 and the top sides of the contact regions 16a, 16b of the cell connector 16 are positioned in substantially the same plane, the connecting section of the connecting element 26 is then configured, for example, in such a way that the two press-in sections of the connecting element are positioned at approximately the same height. In addition, it is possible to configure the connecting section of the connecting element 26 to be at least partially elastic.

The temperature measurement devices 30 will now be explained in more detail by way of example with reference to FIGS. 2 to 4.

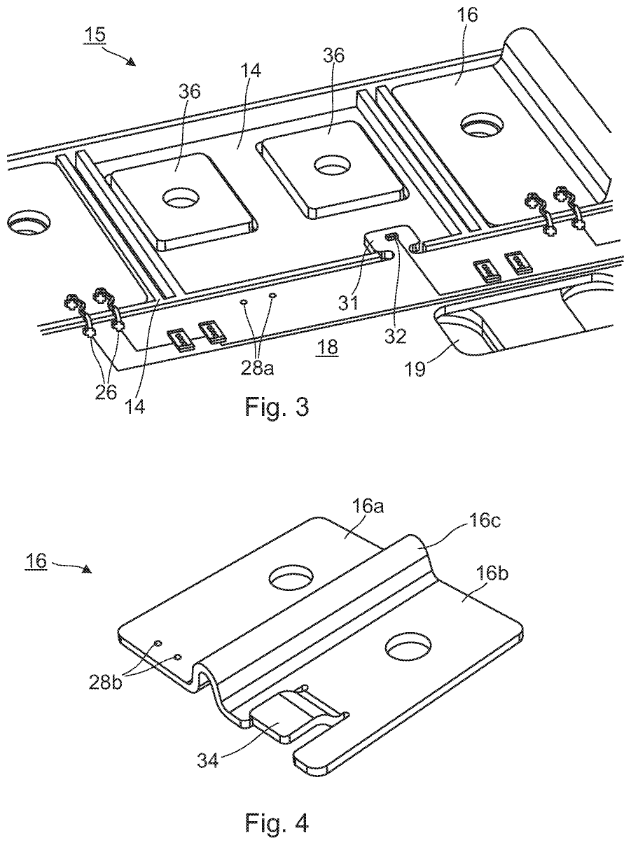

As can be seen best in FIG. 3, the temperature detection device 30 has a printed circuit board edge section 31 which is integrated with the printed circuit board 18 and projects from the printed circuit board 18 into a region of the respective cell connector 16 and on which a temperature sensor 32 is mounted. In other words, the printed circuit board edge section 31 projects from the edge of the basic shape, which is substantially rectangular in this exemplary embodiment, of the printed circuit board 18. The temperature sensor 32 is, for example, an NTC resistor or an NTC thermistor, selectively an SMD version. As can be seen best in FIGS. 2 and 4, the temperature detection device 30 also has a cell connector overlap section 33 of the respective cell connector 16, which cell connector overlap section overlaps the temperature sensor 32 on the printed circuit board edge section 31. This cell connector overlap section 33 preferably substantially overlaps the entire printed circuit board edge section 31. Since the printed circuit board edge section 31 with the temperature sensor 32 is a constituent part of the printed circuit board 18, no additional connecting elements (such as for example the connection elements 26 for the voltage tap points 24) to the printed circuit board 18 are required for the signal source for the temperature detection.

As illustrated in FIG. 2, the temperature detection device 30 preferably also has a heat-conducting layer 34 between the temperature sensor 32 and the cell connector overlap section 33, and therefore the temperature sensor 32 can measure the temperature of the cell connector (and consequently the temperature of the battery cells) more effectively and more reliably. This heat-conducting layer 34 can selectively be attached to the temperature sensor 32 or to the cell connector overlap section 32 of the respective cell connector 16. The heat-conducting layer 34 covers at least the temperature sensor 32, and selectively also the entire cell connector overlap section 33.

As can be seen in FIGS. 2 to 4, the printed circuit board 18 (with its integrated printed circuit board edge sections 31 and the temperature sensors 32 on them) is first placed onto the carrier plate 14 above the battery cells 12 during assembly of the cell-contacting system 15. The cell connectors 16 are then placed onto the carrier plate 14 in the regions of the cell terminals 36 of the battery cells 12. The printed circuit board edge sections 31 of the temperature detection devices 30 are each positioned in a section of a cell terminal 36 in which a contact region 16b of a cell connector 16 is then positioned. Accordingly, the cell connector 16 has the cell connector overlap section 34 in the section of its contact region 16b, as illustrated in FIGS. 2 and 4. After the cell connectors 16 are put into place, the voltage tap points 24 of the cell connectors 16 are then also connected to the printed circuit board 18 by way of the connecting elements 26 being coupled to the contact points 28a, 28b of the printed circuit board.

In the exemplary embodiment of FIGS. 2 to 4, the top side of the printed circuit board edge section 31 is positioned in substantially the same plane as the top side of the printed circuit board 18, the layer thickness of the printed circuit board edge section 31 being able to be somewhat thinner than the layer thickness of the printed circuit board 18. In particular, in the case of the thinner printed circuit board edge section 31, the top side of the printed circuit board edge section can alternatively also be positioned somewhat deeper than the top side of the printed circuit board 18. In addition, the top side of the printed circuit board edge section 31 is preferably positioned somewhat deeper than the top side of the respective cell connector 16, and the cell connector overlap section 33 preferably extends only slightly higher than the other contact region 16b of the respective cell connector 16. In this way, a relatively flat configuration of the cell-contacting system 15 can be achieved in the region of the temperature detection device 30 overall. In addition, it is possible to configure the printed circuit board edge section 31 and/or the cell connector overlap section 34 to be at least partially elastic. Due to such flexibility, for example, it is possible to compensate for movement and swelling of the battery cells 12, which may occur during charging and discharging cycles for example.

The described battery module 10 having the cell-contacting system 15 according to the invention can be used, for example, for vehicles, in particular electric vehicles and hybrid vehicles and in particular motor vehicles and motorcycles, or for energy storage systems or for other electrical devices (e.g. electronic domestic appliances).

The subject matter of the invention is defined by the appended claims.

The exemplary embodiment explained above serves only for better understanding of the invention but is not intended to limit the scope of protection defined by the claims. As will be apparent to a person skilled in the art, even further embodiments are also possible within the scope of the invention, in particular by omitting individual features from the above-described exemplary embodiment or by adding additional features thereto.

The following is a summary list of reference numerals and the corresponding structure used in the above description of the invention:
10 Battery module
12 Battery cell
14 Carrier plate
15 Cell-contacting system
16 Cell connector (power line system)
16a, b Contact regions of the cell connector
16c Compensation region of the cell connector
18 Printed circuit board (signal line system)
19 Ventilation opening
20 Signal management circuit
22 Connecting interface
24 Voltage tap point
26 Connecting element
28a Connecting element contact point on the printed circuit board
28b Connecting element contact point on the cell connector
30 Temperature detection device
31 Printed circuit board edge section
32 Temperature sensor
33 Cell connector overlap section
34 Heat-conducting layer
36 Cell terminal

1. A cell-contacting system for a battery module having a plurality of battery cells with cell terminals, the cell-contacting system comprising:
a plurality of cell connectors for electrically conductively connecting the cell terminals of different battery cells, said plurality of cell connectors each having a top side;
a signal management circuit;
a connecting interface;
a printed circuit board having a plurality of signal lines each configured for passing measurement values from one of said plurality of cell connectors to said signal management circuit or said connecting interface, said printed circuit board having a top side; and
at least one temperature detection device for measuring a temperature of the battery cells at one of said plurality of cell connectors;
said at least one temperature detection device being formed of:
a printed circuit board edge section integrated with said printed circuit board and projecting from said printed circuit board into a region of a respective one of said plurality of cell connectors, said printed circuit board edge section having a top side,
a temperature sensor mounted on said top side of said printed circuit board edge section,
said top side of said printed circuit board edge section being positioned deeper than said top side of said printed circuit board and deeper than said top side of a respective one of said plurality of cell connectors, and
a cell connector overlap section of a respective one of said plurality of cell connectors, said cell connector overlap section overlapping said temperature sensor on said printed circuit board edge section at said top side of said printed circuit board edge section.

2. The cell-contacting system according to claim 1, wherein said temperature sensor has a top side, and said at least one temperature detection device has a heat-conducting layer disposed between said top side of said temperature sensor and said cell connector overlap section of a respective one of said plurality of cell connectors.

3. The cell-contacting system according to claim 2, wherein said heat-conducting layer of said temperature detection device is attached to said temperature sensor or is attached to said cell connector overlap section of a respective one of said plurality of cell connectors.

4. The cell-contacting system according to claim 1, wherein said cell connector overlap section of said temperature detection device entirely overlaps said printed circuit board edge section of said temperature detection device.

5. The cell-contacting system according to claim 1, wherein said plurality of cell connectors each have contact regions, and said cell connector overlap section of said temperature detection device extends higher than any other of said contact regions of a respective one of said plurality of cell connectors.

6. The cell-contacting system according to claim 1, wherein said printed circuit board is disposed in a plane, and said printed circuit board edge section of said temperature detection device is positioned in said plane of said printed circuit board or deeper than said printed circuit board.

7. The cell-contacting system according to claim 1, wherein a respective one of said plurality of cell connectors is disposed in a plane, and said printed circuit board edge section of said temperature detection device is positioned in said plane of said respective one of said plurality of cell connectors or deeper than said one of said plurality of cell connectors.

8. The cell-contacting system according to claim 1, wherein said printed circuit board has a layer thickness, and said printed circuit board edge section of said temperature detection device has a layer thickness equal to said layer thickness of said printed circuit board or a lower layer thickness than said printed circuit board.

9. The cell-contacting system according to claim 1, wherein:
said plurality of cell connectors each have:
two contact regions each associated with a cell terminal of a battery cell,
and
a compensation region disposed between said two contact regions; and said temperature detection device is disposed in a region of one of said two contact regions of a respective one of said plurality of cell connectors.

10. A battery module, comprising:
a plurality of battery cells; and
the cell-contacting system according to claim 1.

11. A method for furnishing a cell-contacting system for a battery module having a plurality of battery cells, the method comprising:
providing a cell-contacting system including a plurality of cell connectors for electrically conductively connecting cell terminals of different battery cells, a printed circuit board having a plurality of signal lines each configured for passing measurement values from one of the plurality of cell connectors to a signal management circuit or a connecting interface, and at least one temperature detection device for measuring a temperature of the battery cells at one of the plurality of cell connectors;
providing the printed circuit board with at least one integrated printed circuit board edge section, the printed circuit board edge section projecting from the printed circuit board into a region of the respective cell connector upon the cell-contacting system being in an assembled state;
mounting a temperature sensor on a top side of the printed circuit board edge section, the top side of the printed circuit board edge section being positioned deeper than a top side of the printed circuit board and deeper than a top side of the respective cell connector; and
providing the respective cell connector with a cell connector overlap section, the cell connector overlap section overlapping the temperature sensor on the printed circuit board edge section at the top side of the printed circuit board edge section upon the cell-contacting system being in the assembled state.

12. The method according to claim 11, which further comprises inserting a heat-conducting layer between a top side of the temperature sensor and the cell connector overlap section of the respective cell connector.
